(19) United States
(12) Patent Application Publication
(10) Pub. No.: US 2024/0402458 A1
(43) Pub. Date: Dec. 5, 2024

(54) LENS BARREL, IMAGING DEVICE, AND DRIVING DEVICE

(71) Applicant: NIKON CORPORATION, Tokyo (JP)

(72) Inventors: Takuji HAMASAKI, Kawasaki-shi (JP); Takumi NAKANO, Kawasaki-shi (JP)

(73) Assignee: NIKON CORPORATION, Tokyo (JP)

(21) Appl. No.: 18/695,228

(22) PCT Filed: Sep. 16, 2022
(86) PCT No.: PCT/JP2022/034799

§ 371 Date: Mar. 25, 2024

(30) Foreign Application Priority Data
Sep. 27, 2021 (JP) 2021-156263

(51) Int. Cl. G02B 7/08

(52) U.S. Cl. CPC G02B 7/08

(57) ABSTRACT

A lens barrel includes a lens holding frame that holds a lens, a drive source, a lead screw that has a first thread groove formed thereon and is rotationally driven by the drive source, a ring-shaped member that has a groove on an inner periphery thereof, the groove being in contact with the first thread groove, a movement member that is connected to the lens holding frame, rotatably holds the ring-shaped member, and moves in an axial direction of the lead screw as the lead screw rotates, and a biasing portion that biases the ring-shaped member toward the lead screw in a direction orthogonal to the axial direction of the lead screw.

### TECHNICAL FIELD

The present disclosure relates to a lens barrel, an imaging device, and a driving device.

### BACKGROUND ART

A mechanism for driving a focus lens using a lead screw and a nut engaged with the lead screw has been proposed (for example, Patent Document 1). Improvement in performance of the drive mechanism for driving the focus lens is desired.

### PRIOR ART DOCUMENT

### Patent Document

Patent Document 1: Japanese Patent Application Laid-Open No. 2011-007938

### SUMMARY OF THE INVENTION

According to a first aspect, there is provided a lens barrel including: a lens holding frame that holds a lens; a drive source; a lead screw that has a first thread groove formed thereon and is rotationally driven by the drive source; a ring-shaped member that has a groove on an inner periphery thereof, the groove being in contact with the first thread groove; a movement member that is connected to the lens holding frame, rotatably holds the ring-shaped member, and moves in an axial direction of the lead screw as the lead screw rotates; and a biasing portion that biases the ring-shaped member toward the lead screw in a direction orthogonal to the axial direction of the lead screw.

According to a second aspect, there is provided a lens barrel including: a lens holding frame that holds a lens; a drive source; a lead screw that has a thread groove formed thereon and is rotationally driven by the drive source; a rotation member that has a groove that is in contact with the thread groove; a movement portion that is connected to the lens holding frame, rotatably holds the rotation member, and moves in an axial direction of the lead screw as the lead screw rotates; and a biasing portion that biases the rotation member toward the lead screw in a direction orthogonal to the axial direction of the lead screw.

According to a third aspect, there is provided an imaging device including the above lens barrel.

According to a fourth aspect, there is provided a driving device including: a drive source; a lead screw that has a thread groove formed thereon and is rotationally driven by the drive source; a ring-shaped member that has a groove on an inner periphery thereof, the groove being in contact with the thread groove; a holding member that rotatably holds the ring-shaped member; a biasing portion that biases the ring-shaped member toward the lead screw in a direction orthogonal to an axis of the lead screw, wherein the ring-shaped member moves in an axial direction of the lead screw together with the holding member while rotating in accordance with rotation of the lead screw.

The configuration of the embodiments described later may be appropriately improved, and at least some of the components may be replaced with other components. Further, the constituent elements whose arrangement is not particularly limited are not limited to the arrangement disclosed in the embodiment, and can be arranged at positions where the functions can be achieved.

### BRIEF DESCRIPTION OF THE DRAWINGS

FIG. 1A and FIG. 1B are cross-sectional views illustrating a configuration of a camera including a lens barrel in accordance with a first embodiment;

FIG. 2A is a perspective view of a lens holding frame and a drive source unit as viewed from the subject side (−Z direction), and FIG. 2B is an enlarged view of the vicinity of a first guide portion as viewed from the +Y direction;

FIG. 3A is a perspective view for describing the structure of the drive source unit, and FIG. 3B is a sectional view of the drive source unit;

FIG. 4A is an exploded perspective view of a movement portion, FIG. 4B is a partial cross-sectional view of the movement portion, FIG. 4C is a perspective view of the movement portion, FIG. 4D is a perspective view of a spring, and FIG. 4E is a cross-sectional view of the movement portion;

FIG. 5A is a plan view of a lead screw and a ring-shaped member as viewed from the −Z direction, FIG. 5B is a view of the lead screw and the ring-shaped member as viewed from a biased direction, and FIG. 5C is a cross-sectional view taken along line B-B in FIG. 5A;

FIG. 6A is a perspective view illustrating a drive source unit in accordance with a second embodiment, and FIG. 6B is a plan view illustrating the drive source unit and a lens holding frame in accordance with the second embodiment as viewed from the subject side;

FIG. 7A is a view of a part of the drive source unit as viewed from the subject side, and FIG. 7B is a cross-sectional view taken along line E-E in FIG. 6B;

FIG. 8 is a cross-sectional view taken along line F-F in FIG. 6B;

FIG. 9A is a perspective view of a drive source unit in accordance with a third embodiment, and FIG. 9B is a plan view of the drive source unit and a lens holding frame in accordance with the third embodiment as viewed from the subject side;

FIG. 10A is a cross-sectional view of the drive source unit in accordance with the third embodiment, and FIG. 10B is a cross-sectional view of a movement portion in accordance with the third embodiment;

FIG. 11A is a plan view of the movement portion in accordance with the third embodiment as viewed from the subject side (−Z direction), and FIG. 11B is a cross-sectional view taken along line D-D in FIG. 11A; and

FIG. 12A is a perspective view of a drive source unit in accordance with a fourth embodiment, FIG. 12B is a perspective view illustrating a state in which a movement portion is fixed to a lens holding frame, and FIG. 12C is a view of the movement portion and the lead screw as viewed from the +Z direction.

### MODES FOR CARRYING OUT THE INVENTION

Hereinafter, a lens barrel in accordance with embodiments will be described in detail with reference to the drawings. In the drawings described below, an XYZ orthogonal coordinate system is appropriately provided for ease of description and understanding. In this coordinate system, a direction from the subject toward a camera body 3 in a camera position (hereinafter, referred to as a normal position) when the photographer captures a horizontally long image with the optical axis OA being horizontal is defined as a +Z direction. Further, a direction toward the right side when viewed from the camera body 3 side in the normal position is defined as a +X direction. In addition, a direction toward the upper side in the normal position is defined as a +Y direction. The shapes, lengths, thicknesses, and other dimensions of the parts illustrated in the embodiments do not necessarily match those of actual parts, and some of the elements may be omitted from the drawings for ease of understanding. In addition, hatching of some components is omitted in some cross-sectional views.

### First Embodiment

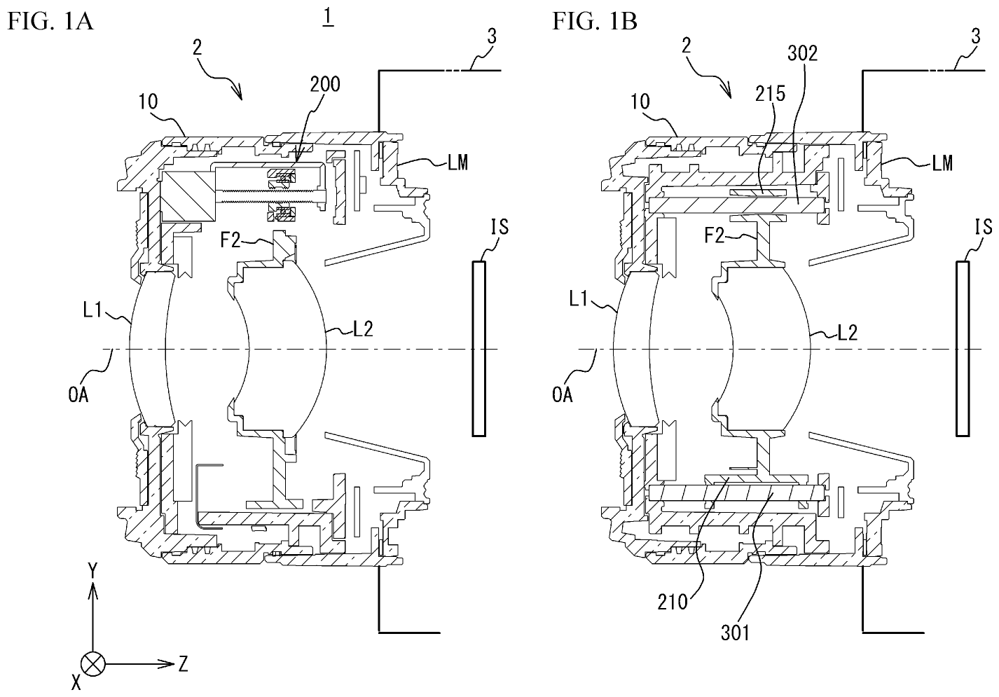

FIG. 1A and FIG. 1B are cross-sectional views illustrating a configuration of a camera 1 including a lens barrel 2 in accordance with a first embodiment. The cutting position is different between FIG. 1A and FIG. 1B.

As illustrated in FIG. 1A and FIG. 1B, the camera 1 includes the camera body 3 and the lens barrel 2. The lens barrel 2 is provided with a lens mount LM at the rear portion (base end portion), and is detachably attached to the camera body 3 by engaging with a body mount (not illustrated) of the camera body 3. In the present embodiment, the lens barrel 2 is attachable to and detachable from the camera body 3, but this does not intend to suggest any limitation, and the lens barrel 2 and the camera body 3 may be integrated.

The camera body 3 includes an image sensor IS, a control unit (not illustrated), and the like. The image sensor IS is composed of a photoelectric conversion element such as a CCD (charge coupled device), for example, and converts a subject image formed by an imaging optical system (the lens barrel 2 attached to the camera body 3) into an electrical signal.

The control unit includes a CPU (central processing unit) and the like, and integrally controls the operation of the camera 1 as a whole, related to photographing including focus driving in the camera body 3 and the lens barrel 2 attached to the camera body 3.

As illustrated in FIG. 1A and FIG. 1B, the lens barrel 2 according to the present embodiment includes lens groups L1 and L2 sequentially arranged along a common optical axis OA. The lens group L1 is held by a fixed barrel 10 provided in the lens barrel 2, and the lens group L2 is held by a lens holding frame F2. The lens group L2 is a focus lens group that moves in the optical axis OA direction during focusing.

The lens barrel 2 is not limited to a single focus lens and may be a so-called zoom lens with a changeable focal length. Each of the lens groups L1 and L2 may include one lens or may include a plurality of lenses. Further, although a lens barrel including two lens groups is described as an example, the lens barrel may include three or more lens groups.

The lens holding frame F2 is driven by a drive source unit 200. The lens holding frame F2 and the drive source unit 200 will be described in detail below.

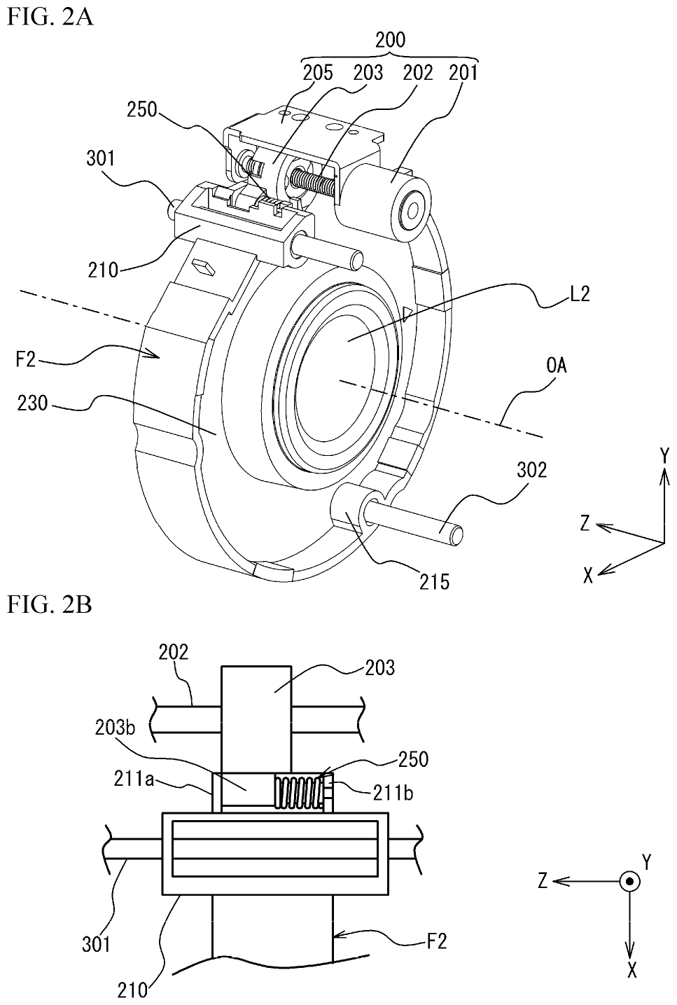

FIG. 2A is a perspective view of the lens holding frame F2 and the drive source unit 200 as viewed from the subject side (−Z direction), and FIG. 2B is an enlarged view of the vicinity of a first guide portion 210, which will be described later, as viewed from the +Y direction.

As illustrated in FIG. 2A, the lens holding frame F2 has a cylindrical portion 230 that holds the lens group L2, and the first guide portion 210 and a second guide portion 215 are provided in the outer peripheral portion of the cylindrical portion 230.

As illustrated in FIG. 1B and FIG. 2A, a guide bar 301, which is fixed to the fixed barrel 10, extends in the optical axis OA direction, and guides the lens holding frame F2 in the optical axis OA direction, is inserted into the first guide portion 210. On the other hand, a rotation restriction bar 302, which is fixed to the fixed barrel 10, extends in the optical axis OA direction, and restricts the movement of the lens holding frame F2 in the rotation direction, is inserted into the second guide portion 215.

As illustrated in FIG. 2B, a first support portion 211a and a second support portion 211b extend in the −X direction from the first guide portion 210. The first support portion 211a and the second support portion 211b support a movement portion 203 (details will be described later) of the drive source unit 200.

Next, the drive source unit 200 will be described. As illustrated in FIG. 2A, the drive source unit 200 includes a stepping motor 201, a lead screw 202, the movement portion 203 that moves along the axis of the lead screw 202 as the lead screw 202 rotates, and an attachment member 205.

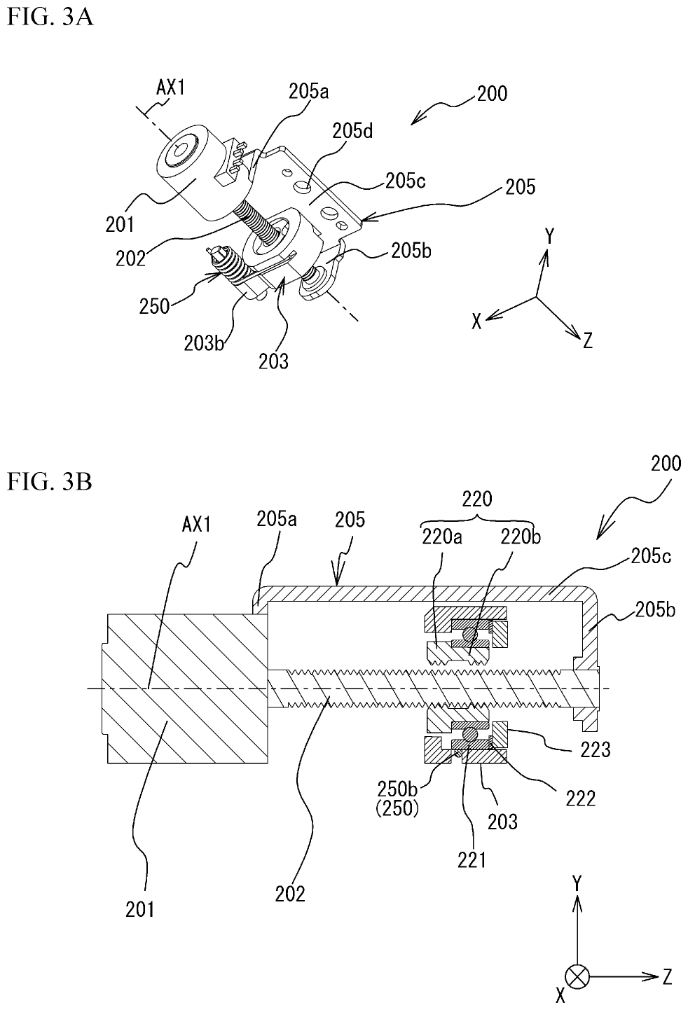

FIG. 3A is a perspective view for describing the configuration of the drive source unit 200, and FIG. 3B is a cross-sectional view of the drive source unit 200.

As illustrated in FIG. 3A and FIG. 3B, the attachment member 205 includes a first portion 205a fixed to the stepping motor 201, a second portion 205b opposed to the first portion 205a, and a third portion 205c extending between the first portion 205a and the second portion 205b in parallel with the lead screw 202. A plurality of holes 205d are formed in the third portion 205c, and the drive source unit 200 is fixed to the fixed barrel 10 by attaching the attachment member 205 to the fixed barrel 10 with screws or the like via the holes 205d.

One end of the lead screw 202 is directly connected to the drive shaft of the stepping motor 201, and the other end of the lead screw 202 is rotatably supported by the second portion 205b of the attachment member 205. The attachment member 205 is mounted on the fixed barrel 10 so that the axis AX1 direction of the lead screw 202 is parallel to the optical axis OA direction.

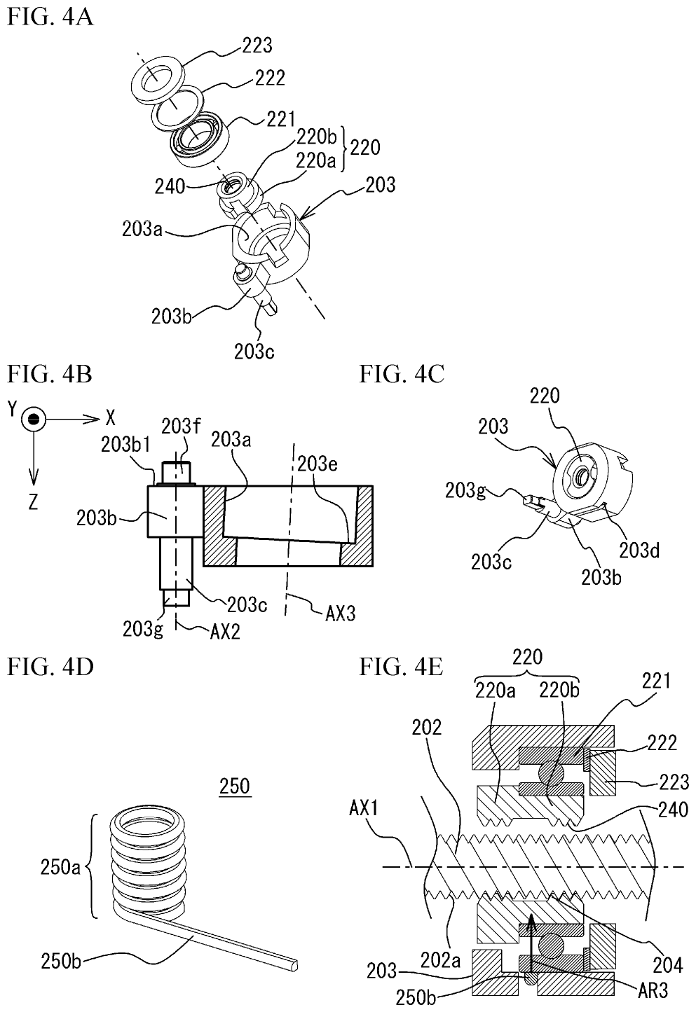

The movement portion 203 moves in the axis AX1 direction of the lead screw 202 in accordance with the rotation of the lead screw 202. FIG. 4A is an exploded perspective view of the movement portion 203, FIG. 4B is a partial cross-sectional view of the movement portion 203, FIG. 4C is a perspective view of the movement portion 203, FIG. 4D is a perspective view of a spring 250, and FIG. 4E is a cross-sectional view of the movement portion 203.

As illustrated in FIG. 4A and FIG. 4B, the movement portion 203 includes a housing portion 203a, a connecting portion 203b, and a spring support portion 203c.

As illustrated in FIG. 4A, the housing portion 203a houses a ring-shaped member 220, a bearing 221, a spacer 222, and a magnet 223. The bearing 221 is not limited to a bearing, and may be any rotatable rolling element such as a bearing.

The ring-shaped member 220 has grooves 240 on its inner peripheral surface, which are in contact with thread grooves 202a of the lead screw 202. The grooves 240 are circumferential grooves formed over the entire inner periphery of the ring-shaped member 220. The ring-shaped member 220 includes a base portion 220a and a fitting portion 220b, and the fitting portion 220b is fitted to the inner ring of the bearing 221 as illustrated in FIG. 4E. The bearing 221 and the ring-shaped member 220 may be integrated with each other.

As illustrated in FIG. 4E, the outer ring of the bearing 221 is fitted to the inner wall of the housing portion 203a. Thus, the ring-shaped member 220 is rotatably held by the movement portion 203. That is, the movement portion 203 rotatably holds the ring-shaped member 220.

As illustrated in FIG. 4E, the spacer 222 is provided so as to cover the outer ring of the bearing 221. The magnet 223 is provided so as to face the bearing 221 with the spacer 222 interposed therebetween. Since the outer ring of the bearing 221 is covered with the spacer 222, the inner ring of the bearing 221 is biased in the axial direction (optical axis OA direction) by the magnet 223. Thus, the axial backlash caused by the axial internal clearance of the bearing 221 can be reduced. The spacer 222 may be provided to cover the inner ring of the bearing 221, and the outer ring of the bearing 221 may be biased in the axial direction by the magnet. Further, if the backlash of the bearing 221 in the axial direction is within the required accuracy, the magnet 223 may be omitted. Further, instead of the magnet 223, a biasing member such as a spring may be used to reduce the backlash in the axial direction.

As illustrated in FIG. 4B, the movement portion 203 has supported portions 203f and 203g supported by the first support portion 211a and the second support portion 211b of the lens holding frame F2, respectively. The supported portions 203f and 203g of the movement portion 203 are supported by the first support portion 211a and the second support portion 211b, respectively, so that the axis AX2 of the spring support portion 203c is parallel to the optical axis OA.

In a state where the supported portions 203f and 203g are supported by the first support portion 211a and the second support portion 211b, respectively, an end surface 203b1 of the connecting portion 203b of the movement portion 203 is in contact with the first support portion 211a of the lens holding frame F2 (see FIG. 2B).

The spring support portion 203c is inserted into the spring 250 to support the spring 250. As a result, the spring 250 is positioned between the connecting portion 203b of the movement portion 203 and the second support portion 211b of the lens holding frame F2 (see FIG. 2B).

As illustrated in FIG. 4D, the spring 250 includes a coil spring portion 250a and a torsion spring portion 250b. As illustrated in FIG. 2B, one end of the coil spring portion 250a is in contact with the connecting portion 203b of the movement portion 203, and the other end is in contact with the second support portion 211b of the lens holding frame F2. As a result, the coil spring portion 250a biases the connecting portion 203b of the movement portion 203 and the second support portion 211b of the lens holding frame F2 in directions in which they are separated from each other. Since the connection portion 203b of the movement portion 203 is pressed against the first support portion 211a of the lens holding frame F2 by the coil spring portion 250a, when the movement portion 203 moves in the optical axis OA direction, the lens holding frame F2 also moves in the optical axis OA direction.

The torsion spring portion 250b is engaged with a stopper portion 203d (see FIG. 4C) formed on the outer periphery of the movement portion 203. As a result, as indicated by an arrow AR3 in FIG. 4E, the ring-shaped member 220 is biased toward the lead screw 202 in the direction orthogonal to the axis AX1 of the lead screw 202. Since the grooves 240 of the ring-shaped member 220 are pressed against the thread grooves 202a of the lead screw 202, the backlash between the ring-shaped member 220 and the lead screw 202 is reduced.

As illustrated in FIG. 4B, a bottom portion 203e of the housing portion 203a of the movement portion 203 is inclined with respect to a plane perpendicular to the axis AX2 of the spring support portion 203c. Thus, the axis AX3 direction of the ring-shaped member 220, the bearing 221, the spacer 222, and the magnet 223 is not parallel to the axis AX2 direction of the spring support portion 203c (the axis AX1 direction of the lead screw 202). This point will be described in more detail.

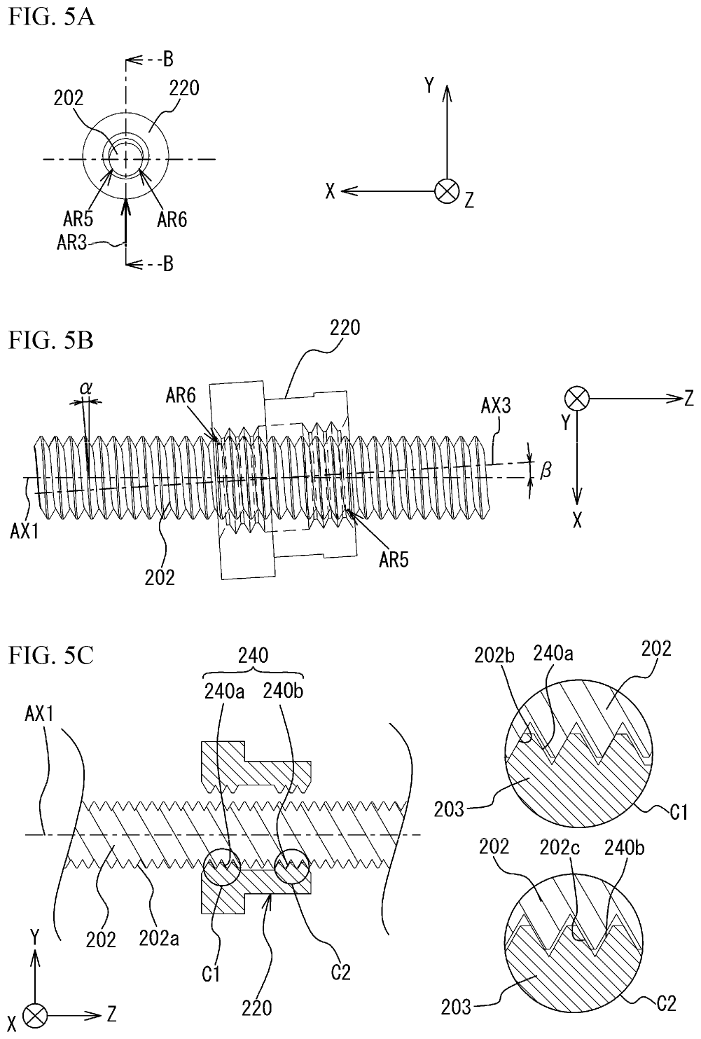

FIG. 5A is a view of the lead screw 202 and the ring-shaped member 220 as viewed from the −Z direction, FIG. 5B is a view of the lead screw 202 and the ring-shaped member 220 as viewed from the biased direction of the ring-shaped member 220 (the direction indicated by the arrow AR3 in FIG. 5A), and FIG. 5C is a cross-sectional view taken along line B-B in FIG. 5A.

As illustrated in FIG. 5B, in the present embodiment, the ring-shaped member 220 is inclined in accordance with the lead angle α of the lead screw 202. That is, an angle R between the axis AX1 of the lead screw 202 and the axis AX3 of the ring-shaped member 220 is substantially equal to the lead angle α.

As illustrated in FIG. 5C, the ring-shaped member 220 and the lead screw 202 are in contact with each other at one side of the lead screw 202 and are separated from each other at the other side in the biasing direction of the spring 250. The lead screw 202 has a first flank surface 202b and a second flank surface 202c that are opposed to each other in the axis AX1 direction. The grooves 240 formed on the inner periphery of the ring-shaped member 220 include a first groove 240a and a second groove 240b. The first groove 240a and the second groove 240b are circumferential grooves formed over the entire inner periphery of the ring-shaped member 220. The first groove 240a is in contact with the first flank surface 202b at the contact point indicated by an arrow AR6 in FIG. 5A and FIG. 5B. On the other hand, the second groove 240b is in contact with the second flank surface 202c at the contact point indicated by an arrow AR5 in FIG. 5A and FIG. 5B. That is, the grooves 240 include the first groove 240a and the second groove 240b that are different in phase. The enlarged views denoted by reference numerals C1 and C2 in FIG. 5C are cross-sectional views at the contact points denoted by the arrows AR6 and AR5 in FIG. 5A and FIG. 5B, respectively.

As described above, the ring-shaped member 220 and the lead screw 202 are in contact with each other at at least two points indicated by the arrows AR5 and AR6 in FIG. 5A and FIG. 5B, because of the inclination of the ring-shaped member 220 in accordance with the lead angle α of the lead screw 202, and the configuration of the first groove 240a and the configuration of the second groove 240b. The positions of the two points at which the ring-shaped member 220 and the lead screw 202 are in contact with each other are different in the axial AX1 direction of the lead screw 202 and in the direction orthogonal to the axis AX1 direction when viewed from the biasing direction in which the spring 250 biases the ring-shaped member 220. This allows the posture of the ring-shaped member 220 with respect to the lead screw 202 to be stably maintained. In FIG. 5A, the contact point indicated by the arrow AR5 and the contact point indicated by the arrow AR6 are not actually on the same plane, but are illustrated on the same plane for ease of understanding.

As described above, the grooves 240 of the ring-shaped member 220 include the first groove 240a and the second groove 240b that are different in phase. Thus, when the ring-shaped member 220 moves toward either the subject or the camera body 3 in the optical axis OA direction, either the first groove 240a or the second groove 240b is in contact with the thread groove 202a of the lead screw 202 (no gap is formed between the thread groove 202a of the lead screw 202 and the ring-shaped member 220), and therefore the ring-shaped member 220 follows the lead screw 202 without delay. This improves the accuracy of the movement of the lens holding frame F2 in the optical axis OA direction and improves the accuracy of position control of the lens group L2.

Since the ring-shaped member 220 is rotatably supported via the bearing 221, when the lead screw 202 rotates, the ring-shaped member 220 is pushed by the first flank surface 202b or the second flank surface 202c of the thread groove 202a of the lead screw 202 and moves in the axis AX1 direction of the lead screw 202 while rotating. As a result, the movement portion 203 holding the ring-shaped member 220 also moves in the axis AX1 direction of the lead screw, and thus the lens holding frame F2 connected to the movement portion 203 can be moved in the optical axis OA direction.

In the case that the ring-shaped member 220 is supported so as not to be rotatable, when the lead screw 202 rotates, the ring-shaped member 220 is pushed by the first flank surface 202b or the second flank surface 202c of the thread groove 202a of the lead screw 202 without rotating, and moves in the axis AX1 direction of the lead screw. In this case, sliding friction is generated between the ring-shaped member 220 and the lead screw 202, and thus a load due to the sliding friction is applied to the stepping motor 201.

In contrast, in the case that the ring-shaped member 220 is rotatably supported as described in the first embodiment, when the lead screw 202 rotates, the ring-shaped member 220 rotates around the axis AX1 of the lead screw 202, and therefore, the friction generated between the ring-shaped member 220 and the lead screw 202 is rolling friction. Since the rolling friction is much smaller than the sliding friction, the load applied to the stepping motor 201 when the movement portion 203 is moved in the axis AX1 direction can be reduced. Thus, for example, when the lens holding frame F2 having the same weight is moved by using the stepping motor 201 having the same power, the lens holding frame F2 can be moved at a higher speed than in the case where the ring-shaped member 220 is supported so as not to be rotatable (in the case where sliding friction is generated). Further, for example, when the stepping motor 201 having the same power is used, the lens holding frame F2 heavier than that in the case where the ring-shaped member 220 is supported so as not to be rotatable (in the case where sliding friction occurs) can be moved. Further, when the lens holding frame F2 having the same weight is moved, the stepping motor 201 having a smaller power can be used than in the case that the ring-shaped member 220 is supported so as not to be rotatable (when sliding friction is generated), and therefore, the drive source unit 200 can be miniaturized. As described above, the performance of the drive source unit 200 can be improved.

Further, since the shape of the thread grooves 202a of the lead screw 202 and the shape of the grooves 240 of the ring-shaped member 220 are different from each other, when the lead screw 202 rotates, the ring-shaped member 220 can move in the axis AX1 direction of the lead screw 202 while rotating.

As described above in detail, in the first embodiment, the lens barrel 2 includes the lens holding frame F2 that holds the lens group L2, the stepping motor 201, the ring-shaped member 220, the movement portion 203, and the spring 250. The lead screw 202 has the thread grooves 202a formed on the outer periphery thereof, and is rotationally driven by the stepping motor 201. The ring-shaped member 220 has the grooves 240 on the inner periphery that are in contact with the thread grooves 202a. The movement portion 203 is connected to the lens holding frame F2, rotatably holds the ring-shaped member 220, and moves in the axis AX1 direction of the lead screw 202 as the lead screw 202 rotates. The spring 250 biases the ring-shaped member 220 toward the lead screw in a direction orthogonal to the axis AX1 direction of the lead screw 202. The ring-shaped member 220 is rotatable around the axis AX1 of the lead screw 202, and rotates as the lead screw 202 rotates. Thus, as described above, when the ring-shaped member 220 moves in the axis AX1 direction as the lead screw 202 rotates, rolling friction is generated between the ring-shaped member 220 and the lead screw 202. Therefore, as compared with the case where the ring-shaped member 220 is supported so as not to be rotatable (the case where sliding friction is generated), it is possible to increase the weight of the lens holding frame F2, to reduce the size of the drive source unit 200, and to increase the speed of movement of the lens holding frame F2. As described above, the performance of the drive source unit 200 can be improved.

In the first embodiment, the grooves 240 of the ring-shaped member 220 are circumferential grooves formed over the entire inner periphery. Thus, when the lead screw 202 rotates, the ring-shaped member 220 can be moved in the axis AX1 direction of the lead screw 202.

In the first embodiment, the lead screw 202 has the first flank surface 202b and the second flank surface 202c opposed to each other in the axis AX1 direction, and the grooves 240 of the ring-shaped member 220 include the first groove 240a, which is in contact with the first flank surface 202b, and the second groove 240b, which is in contact with the second flank surface 202c. Thus, when the ring-shaped member 220 moves toward either the subject or the camera body 3 in the optical axis OA direction, either the first groove 240a or the second groove 240b is in contact with the thread groove 202a of the lead screw 202 (no clearance is formed between the thread groove 202a of the lead screw 202 and the ring-shaped member 220), and therefore the ring-shaped member 130 follows the lead screw 202 without delay. Therefore, the accuracy of movement of the lens holding frame F2 in the optical axis OA direction can be improved, and the accuracy of position control of the lens group L2 is improved. As described above, the performance of the drive source unit 200 can be improved.

In the first embodiment, the ring-shaped member 220 is inclined in accordance with the lead angle α of the lead screw 202. Because of the inclination of the ring-shaped member 220 in accordance with the lead angle α of the lead screw 202, and the configuration of the first groove 240a and the configuration of the second groove 240b, the thread grooves 202a of the lead screw 202 and the grooves 240 of the ring-shaped member 220 are in contact with each other at at least two points. When viewed from the biasing direction in which the spring 250 biases the ring-shaped member 220, at least two positions at which the thread grooves 202a of the lead screw 202 and the grooves 240 of the ring-shaped member 220 are in contact with each other are different in the axis AX1 direction of the lead screw 202 and in the direction orthogonal to the axis AX1 direction. This configuration allows the posture of the ring-shaped member 220 with respect to the lead screw 202 to be stably maintained, and thus the ring-shaped member 220 can be stably moved.

In the first embodiment, the magnet 223 is provided to bias the inner ring of the bearing 221 in the optical axis OA direction. This can reduce the axial backlash of the bearing 221.

In the first embodiment, the first groove 240a of the grooves 240 of the ring-shaped member 220 is in contact with the first flank surface 202b of the thread groove 202a of the lead screw 202, and the second groove 240b is in contact with the second flank surface 202c of the thread groove 202a. However, the first groove 240a may be in contact with the second flank surface 202c, and the second groove 240b may be in contact with the first flank surface 202b.

In the above first embodiment, the grooves 240 are formed on the inner periphery of the ring-shaped member 220, but thread grooves may be formed. In this case, by making the pitch of the thread grooves 202a of the lead screw 202 and the pitch of the thread grooves of the ring-shaped member 220 different, the ring-shaped member 220 can move in the axis AX1 direction of the lead screw 202 while rotating in accordance with the rotation of the lead screw 202, and therefore, the same effect as in the first embodiment can be achieved.

### Second Embodiment

In a second embodiment, a configuration in which a ring-shaped member 220A has grooves 241 on its outer periphery will be described.

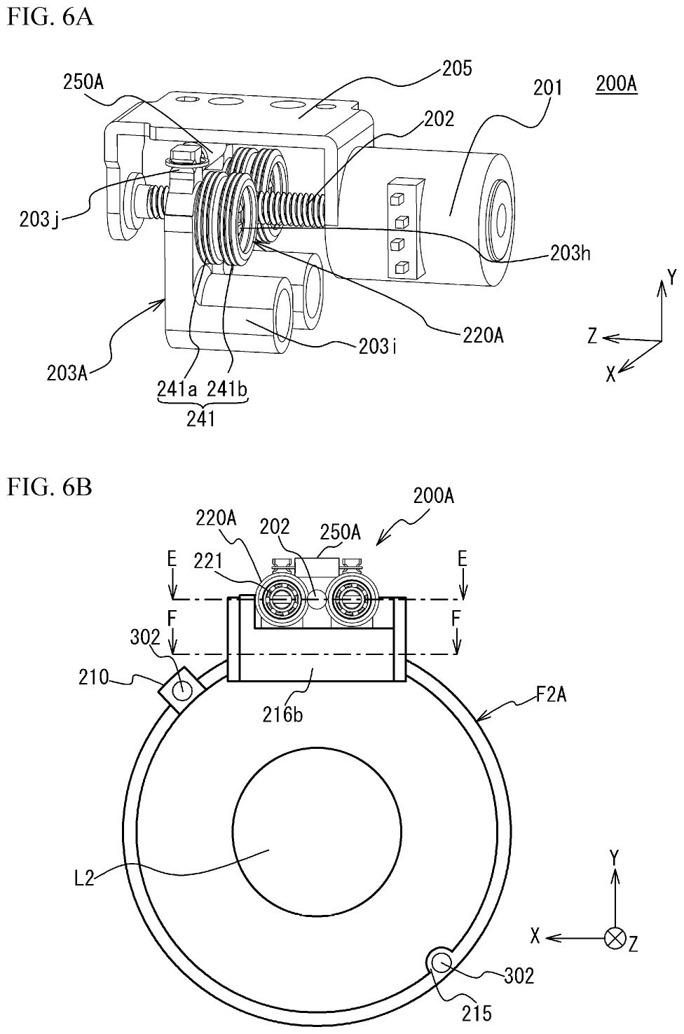

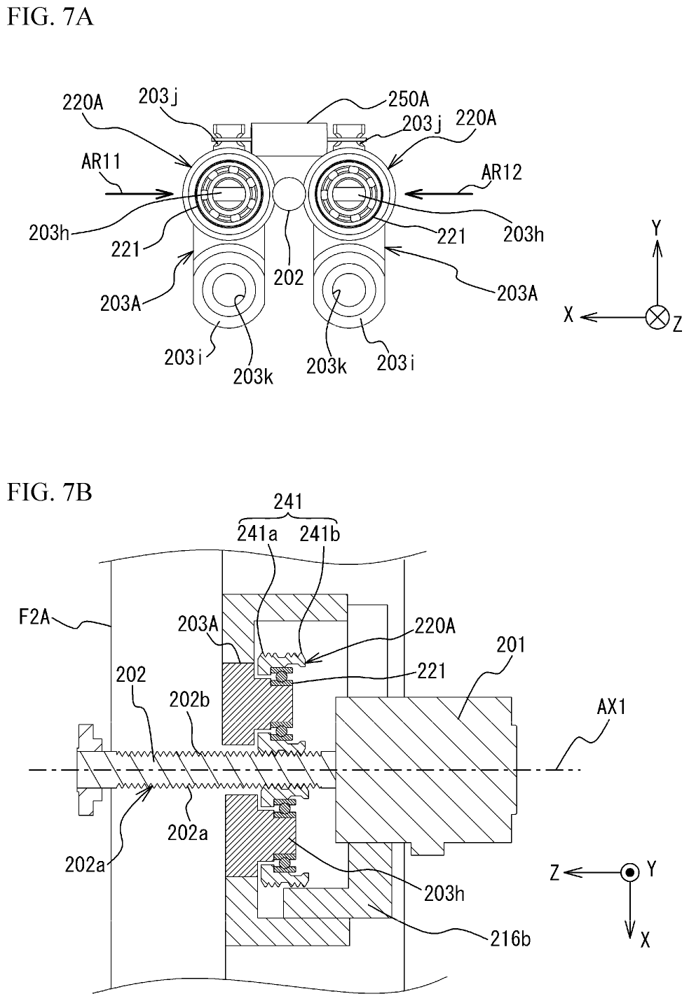

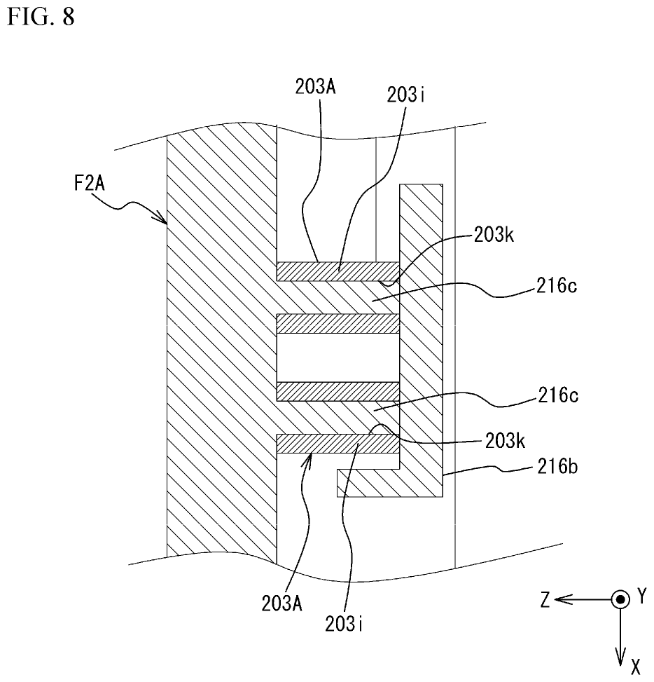

FIG. 6A is a perspective view illustrating a drive source unit 200A in accordance with the second embodiment, and FIG. 6B is a plan view illustrating the drive source unit 200A and a lens holding frame F2A in accordance with the second embodiment as viewed from the subject side. FIG. 7A is a view of a part of the drive source unit 200A as viewed from the subject side (−Z direction), and FIG. 7B is a cross-sectional view taken along line E-E in FIG. 6B. FIG. 8 is a cross-sectional view taken along line F-F in FIG. 6B. In the following embodiments, the same components as those in the first embodiment are denoted by the same reference numerals, and detailed description thereof will be omitted.

As illustrated in FIG. 6B, the lens holding frame F2A according to the second embodiment is different from the lens holding frame F2 according to the first embodiment in that the lens holding frame F2A includes none of the first support portion 211a and the second support portion 211b extending in the −X direction from the first guide portion 210. In FIG. 6B, the stepping motor 201 and the attachment member 205 of the drive source unit 200A are not illustrated.

As illustrated in FIG. 6A, the drive source unit 200A includes the stepping motor 201, the lead screw 202, a pair of movement portions 203A, the attachment member 205, and a tension spring 250A.

The pair of movement portions 203A are opposed to each other with the lead screw 202 interposed therebetween. Each of the pair of movement portions 203A includes a connecting portion 203i connected to the lens holding frame F2A and a holding portion 203h that rotatably holds the ring-shaped member 220A.

As illustrated in FIG. 7A, the connecting portion 203i has a through hole 203k that penetrates through the connecting portion 203i in the optical axis OA direction (Z-axis direction). As illustrated in FIG. 8, a connection shaft 216c of the lens holding frame F2A is inserted into the through hole 203k, and a cap portion 216b is fixed to the end portion of the connection shaft 216c. Thus, the lens holding frame F2A and the movement portion 203A are connected to each other.

As illustrated in FIG. 7A, the holding portion 203h holds the bearing 221 by being fitted to the inner ring of the bearing 221, and the outer ring of the bearing 221 is fitted to the inner periphery of the ring-shaped member 220A. Thus, the movement portion 203A rotatably holds the ring-shaped member 220A. Since the pair of movement portions 203A are opposed to each other across the lead screw 202, the pair of ring-shaped members 220A sandwich the lead screw 202.

As illustrated in FIG. 7B, the grooves 241 that are in contact with the thread grooves 202a of the lead screw 202 are formed on the outer periphery of the ring-shaped member 220A. The grooves 241 include a first groove 241a that is in contact with the first flank surface 202b of the thread groove 202a and a second groove 241b that is in contact with the second flank surface 202c. That is, the groove 241 includes the first groove 241a and the second groove 241b that are different in phase. Thus, as in the first embodiment, it is possible to prevent the ring-shaped member 220A from being delayed before the ring-shaped member 220A follows the lead screw 202.

As illustrated in FIG. 7A, a fastening portion 203j for fastening the tension spring 250A is formed at one end (+Y-side end) of each of the pair of movement portions 203A. Since the pair of ring-shaped members 220A sandwich the lead screw 202, when the tension spring 250A is engaged with the pair of fastening portions 203j while the pair of connecting portions 203i are connected to the lens holding frame F2A, the pair of ring-shaped members 220A are biased toward the lead screw 202 as indicated by arrows AR11 and AR12 in FIG. 7A, respectively. Therefore, the backlash between the ring-shaped member 220A and the lead screw 202 is reduced.

When the lead screw 202 rotates, the two ring-shaped members 220A are pushed by the first flank surface 202b or the second flank surface 202c of the thread groove 202a of the lead screw while rotating, and move in the axis AX1 direction of the lead screw 202 (that is, the optical axis OA direction). In the second embodiment, the friction generated between the lead screw 202 and the ring-shaped member 220A is rolling friction, and therefore, the load applied to the stepping motor 201 can be reduced as compared with the case where the ring-shaped member 220A does not rotate.

### Third Embodiment

A third embodiment describes a case where two ring-shaped members 220C and 220D are arranged in the axis AX1 direction of the lead screw 202.

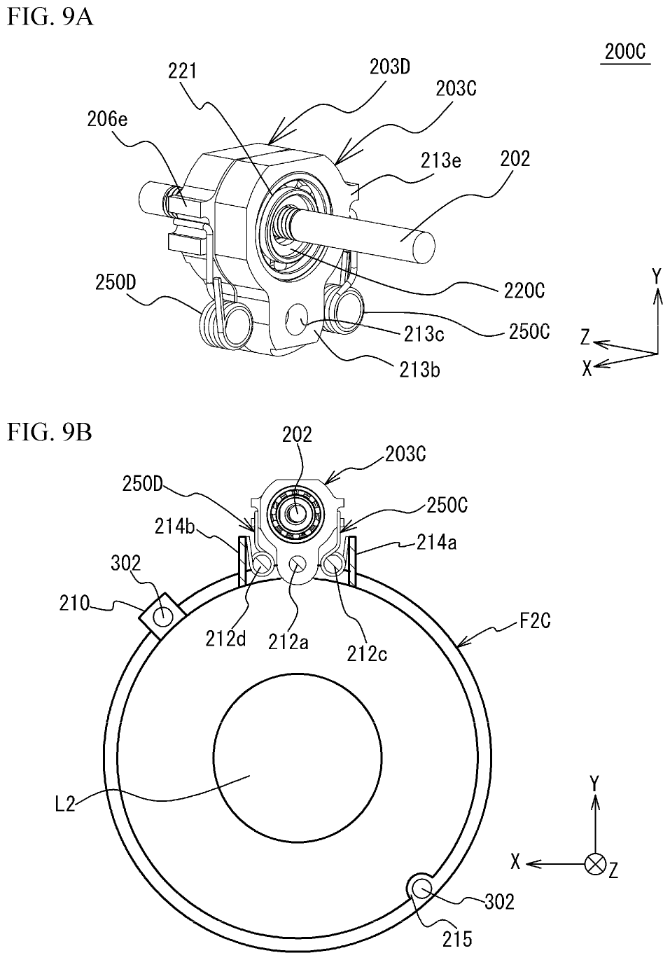

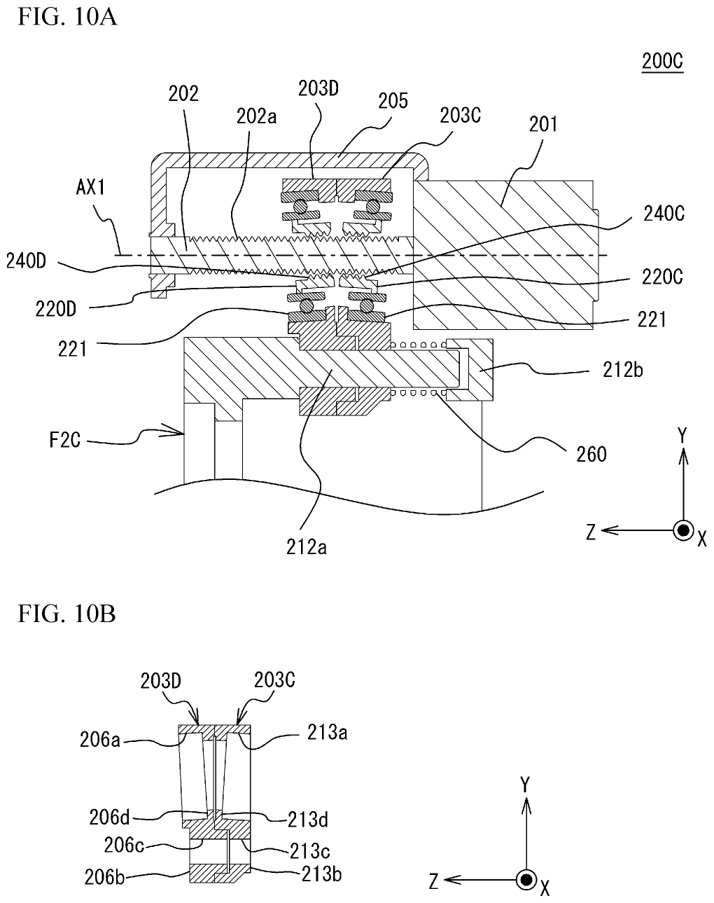

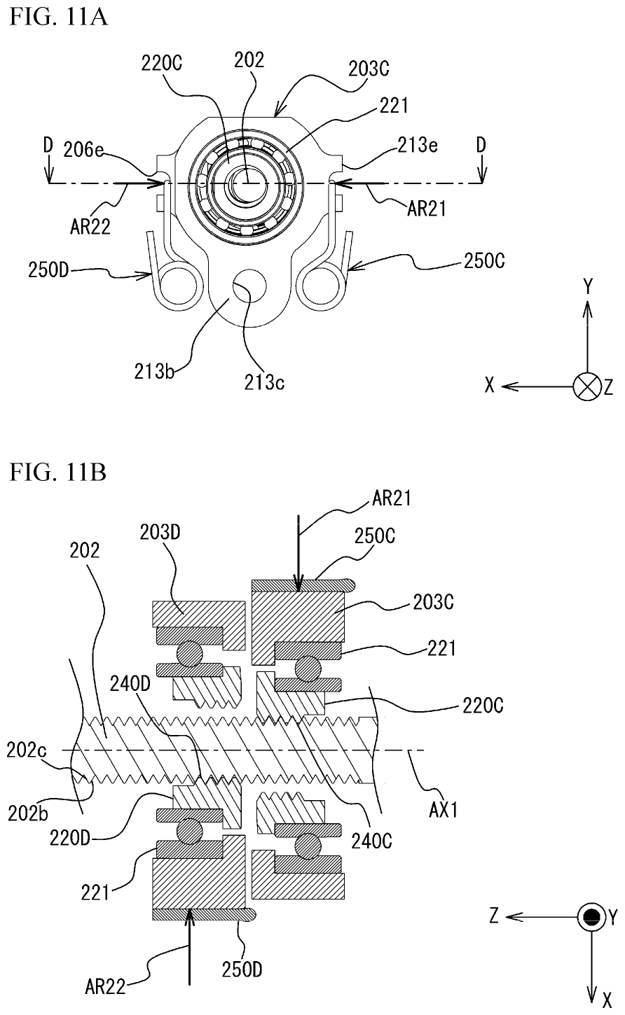

FIG. 9A is a perspective view of a drive source unit 200C in accordance with the third embodiment, and FIG. 9B is a plan view of the drive source unit 200C and a lens holding frame F2C according to the third embodiment as viewed from the subject side. FIG. 10A is a cross-sectional view of the drive source unit 200C, and FIG. 10B is a cross-sectional view of movement portions 203C and 203D. Further, FIG. 11A is a plan view of the movement portions 203C and 203D according to the third embodiment as viewed from the −Z direction, and FIG. 11B is a cross-sectional view taken along line D-D in FIG. 11A. In FIG. 9A, the stepping motor 201 and the attachment member 205 are not illustrated.

As illustrated in FIG. 9A and FIG. 10A, the drive source unit 200C according to the third embodiment includes the stepping motor 201, the lead screw 202, the ring-shaped members 220C and 220D, the movement portions 203C and 203D, and torsion springs 250C and 250D.

As illustrated in FIG. 10B, the movement portion 203C includes a housing portion 213a that houses the ring-shaped member 220C and the bearing 221, and a connecting portion 213b that is connected to the lens holding frame F2C. The outer ring of the bearing 221 is fitted to the inner wall of the housing portion 213a, and the outer periphery of the ring-shaped member 220C is fitted to the inner ring of the bearing 221. Thus, the ring-shaped member 220C is rotatably held by the movement portion 203C. Grooves 240C that are in contact with the thread grooves 202a of the lead screw 202 are formed on the inner periphery of the ring-shaped member 220C. The groove 240C is in contact with, for example, the first flank surface 202b of the thread groove 202a of the lead screw 202.

A bottom portion 213d of the housing portion 213a is inclined in accordance with the lead angle of the lead screw 202. Thus, the ring-shaped member 220C is inclined in accordance with the lead angle. Therefore, as described in the first embodiment, the lead screw 202 and the ring-shaped member 220C are in contact with each other at at least two points because of the inclination of the ring-shaped member 220C in accordance with the lead angle and the configuration of the groove 240C of the ring-shaped member 220C, and the posture of the ring-shaped member 220C with respect to the lead screw 202 can be thereby stably maintained.

The connecting portion 213b is provided with a through hole 213c into which a connecting shaft 212a of the lens holding frame F2C is inserted. Further, a stopper portion 213e with which one end of the torsion spring 250C is engaged is formed on the side surface of the movement portion 203C.

As illustrated in FIG. 9B, the torsion spring 250C is supported by a spring support shaft 212c of the lens holding frame F2C, one end of the torsion spring 205C is engaged with the stopper portion 213e of the movement portion 203C, and the other end of the torsion spring 250C is in contact with a first restriction portion 214a of the lens holding frame F2C. As a result, as indicated by an arrow AR21 in FIG. 11A, the torsion spring 250C biases the ring-shaped member 220C toward the lead screw 202 in a direction orthogonal to the axis AX1 direction of the lead screw 202. As a result, as indicated by the arrow AR21 in FIG. 11B, the ring-shaped member 220C is pressed against the lead screw 202, and the backlash between the lead screw 202 and the ring-shaped member 220C is reduced.

As illustrated in FIG. 10B, the movement portion 203D includes a housing portion 206a that houses the ring-shaped member 220D and the bearing 221, and a connecting portion 206b that is connected to the lens holding frame F2C. The outer ring of the bearing 221 is fitted to the inner wall of the housing portion 206a, and the outer periphery of the ring-shaped member 220D is fitted to the inner ring of the bearing 221. Thus, the ring-shaped member 220D is rotatably held by the movement portion 203D. Grooves 240D that are in contact with the thread grooves 202a of the lead screw 202 are formed on the inner periphery of the ring-shaped member 220D. The groove 240D is in contact with, for example, the second flank surface 202c of the thread groove 202a of the lead screw 202. Therefore, when the lead screw 202 rotates, either the groove 240C of the ring-shaped member 220C or the groove 240D of the ring-shaped member 220D is in contact with the thread groove 202a of the lead screw 202, and thus, for example, the same effect as the first groove 240a and the second groove 240b formed on the inner periphery of the ring-shaped member 220 according to the first embodiment can be obtained.

A bottom portion 206d of the housing portion 206a is inclined in accordance with the lead angle of the lead screw 202. Thus, the ring-shaped member 220D is inclined in accordance with the lead angle. Therefore, as described in the first embodiment, the lead screw 202 and the ring-shaped member 220D are in contact with each other at at least two points because of the inclination of the ring-shaped member 220D in accordance with the lead angle and the configuration of the groove 240D of the ring-shaped member 220, and the posture of the ring-shaped member 220D with respect to the lead screw 202 can be therefore stably maintained.

Since the lead screw 202 and the ring-shaped member 220C are in contact with each other at at least two points and the lead screw 202 and the ring-shaped member 220D are in contact with each other at at least two points, the contact points with the lead screw 202 are four points at different positions in the axis AX1 direction of the lead screw 202 and the direction orthogonal to the axis AX1 direction. This determines the posture of the lens holding frame F2C, and therefore, the guide bar 301 may be omitted in the third embodiment. Further, by arranging the ring-shaped member 220C and the ring-shaped member 220D so as to be shifted in phase in the axial direction, it is possible to reduce backlash of the bearing 221 in the axial direction, and it is possible to omit a backlash eliminating member such as the magnet 223 described in the first embodiment.

The connecting portion 206b is provided with a through hole 206c into which the connecting shaft 212a of the lens holding frame F2C is inserted. Further, a stopper portion 206e with which the torsion spring 250D is engaged is formed on the side surface of the movement portion 203D.

As illustrated in FIG. 9B, the torsion spring 250D is supported by a spring support shaft 212d of the lens holding frame F2C, one end of the torsion spring 250D is engaged with the stopper portion 206e of the movement portion 203C, and the other end of the torsion spring 250D is in contact with the second restriction portion 214b of the lens holding frame F2C. As a result, as indicated by an arrow AR22 in FIG. 11A, the torsion spring 250D biases the ring-shaped member 220D toward the lead screw 202 in a direction orthogonal to the axis AX1 direction of the lead screw 202. As a result, as indicated by the arrow AR22 in FIG. 11B, the ring-shaped member 220D is pressed against the lead screw 202, and the backlash between the lead screw 202 and the ring-shaped member 220D is reduced.

A cap portion 212b is fixed to an end of the connection shaft 212a, which penetrates through the through hole 213c of the movement portion 203C and the through hole 206c of the movement portion 203D, of the lens holding frame F2C. A compression coil spring 260 is provided between the movement portion 203C and the cap portion 212b, and biases the movement portion 203C and the cap portion 212b in directions in which they are separated from each other. Thus, when the movement portions 203C and 203D move in the optical axis OA direction, the lens holding frame F2C can also move in the optical axis OA direction.

In the third embodiment, when the lead screw 202 rotates, the ring-shaped member 220C rotatably held by the movement portion 203C and the ring-shaped member 220D rotatably held by the movement portion 203D move in the axis AX1 direction of the lead screw 202 while rotating. Since the friction generated between the lead screw 202 and the ring-shaped member 220C and the friction between the lead screw 202 and the ring-shaped member 220D are rolling friction, the load applied to the stepping motor 201 can be reduced compared to a case where the ring-shaped members 220C and 220D do not rotate.

In the third embodiment, the groove 240C of the ring-shaped member 220C is in contact with the first flank surface 202b of the thread groove 202a of the lead screw 202, and the groove 240D of the ring-shaped member 220D is in contact with the second flank surface 202c of the thread groove 202a. However, the groove 240C may be in contact with the second flank surface 202c, and the groove 240D may be in contact with the first flank surface 202b.

### Fourth Embodiment

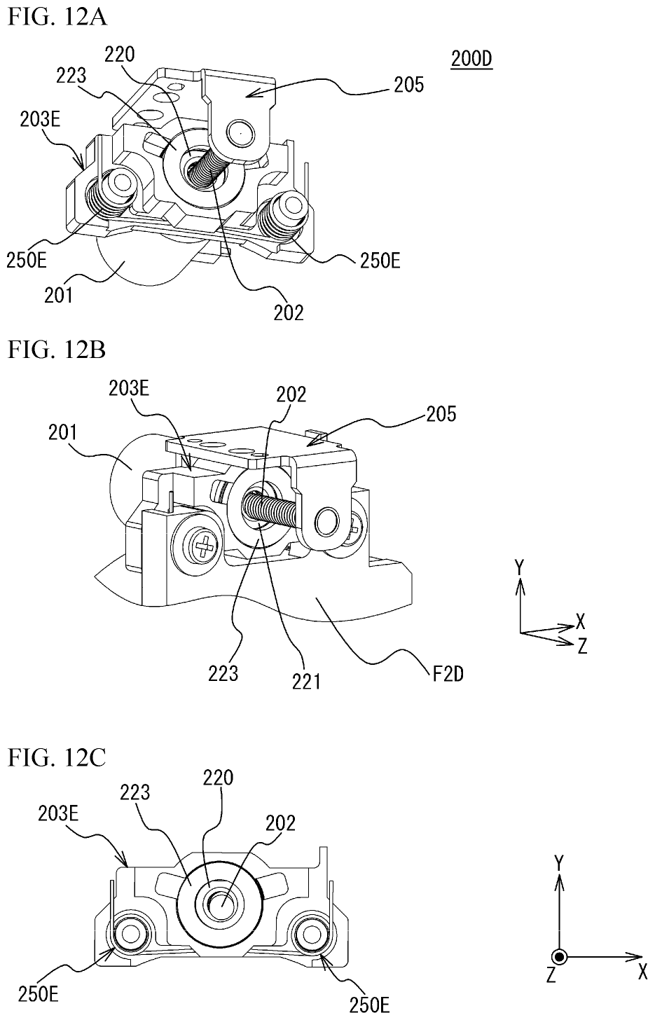

FIG. 12A is a perspective view of a drive source unit 200D in accordance with a fourth embodiment, FIG. 12B is a perspective view illustrating a state in which a movement portion 203E is fixed to a lens holding frame F2D, and FIG. 12C is a view illustrating the movement portion 203E and the lead screw 202 as viewed from the +Z direction. In the fourth embodiment, the shape of the movement portion 203E is different from that of the movement portion 203 of the first embodiment.

As illustrated in FIG. 12A, in the fourth embodiment, the movement portion 203E is connected to the lens holding frame F2D by screws or the like. The ring-shaped member 220 is biased toward the lead screw 202 in a direction orthogonal to the axis AX1 of the lead screw 202 by two torsion springs 250E. Other configurations are the same as those of the first embodiment, and thus detailed description thereof will be omitted. In the configuration according to the fourth embodiment, the ring-shaped member 220 moves in the optical axis OA direction while rotating in accordance with the rotation of the lead screw 202, and thus the load applied to the stepping motor 201 can be reduced.

The above embodiments are preferred examples. However, the present disclosure is not limited to this, and various modifications can be made without departing from the scope of the present disclosure, and arbitrary constituent features may be combined.

DESCRIPTION OF REFERENCE NUMERALS

| | |
|---|---|
| 1 | camera |
| 2 | lens barrel |
| 3 | camera body |
| 201 | stepping motor |
| 202 | lead screw |
| 202a | thread groove |
| 202b | first flank surface |
| 202c | second flank surface |
| 203, 203A, 203C to 203E | movement portion |
| 220, 220A, 220C, 220D | ring-shaped member |
| 221 | bearing |
| 223 | magnet |
| 250 | spring |
| 250A | tension spring |
| 250C, 250D, 250E | torsion spring |
| L2 | lens group |
| F2, F2A, F2C, F2D | lens holding frame |

1. A lens barrel comprising:
a lens holding frame that holds a lens;
a drive source;
a lead screw that has a first thread groove formed thereon and is rotationally driven by the drive source;
a ring-shaped member that has a groove on an inner periphery thereof, the groove being in contact with the first thread groove;
a movement member that is connected to the lens holding frame, rotatably holds the ring-shaped member, and moves in an axial direction of the lead screw as the lead screw rotates; and
a biasing portion that biases the ring-shaped member toward the lead screw in a direction orthogonal to the axial direction of the lead screw.

2. The lens barrel according to claim 1, wherein the ring-shaped member is rotatable around an axis of the lead screw.

3. The lens barrel according to claim 1, wherein the ring-shaped member rotates with rotation of the lead screw.

4. The lens barrel according to claim 1, further comprising a rotation member that rotatably supports the ring-shaped member with respect to the movement member.

5. The lens barrel according to claim 4, further comprising a magnet that biases a part of the rotation member in an optical axis direction.

6. The lens barrel according to claim 1, wherein the groove is a circumferential groove formed over an entirety of the inner periphery.

7. The lens barrel according to claim 1,
wherein the groove is a second thread groove formed over an entirety of the inner periphery, and
wherein a pitch of the first thread groove is different from a pitch of the second thread groove.

8. The lens barrel according to claim 1, wherein an axial direction of the ring-shaped member is inclined with respect to the axial direction of the lead screw.

9. The lens barrel according to claim 1, wherein the ring-shaped member and the lead screw are in contact with each other at one side of the lead screw and are separated from each other at another side of the lead screw in a biasing direction of the biasing portion.

10. The lens barrel according to claim 1, wherein the first thread groove and the groove are in contact with each other at at least two points.

11. The lens barrel according to claim 10, wherein when viewed from a biasing direction in which the biasing portion biases the ring-shaped member, positions of the at least two points at which the first thread groove and the groove are in contact with each other are different in the axial direction of the lead screw and in a direction orthogonal to the axial direction of the lead screw.

12. The lens barrel according to claim 1,
wherein the first thread groove has a first flank surface and a second flank surface that are opposed to each other in the axial direction, and
wherein the groove includes a first groove that is in contact with the first flank surface and a second groove that is in contact with the second flank surface.

13. A lens barrel comprising:
a lens holding frame that holds a lens;
a drive source;
a lead screw that has a thread groove formed thereon and is rotationally driven by the drive source;
a rotation member that has a groove that is in contact with the thread groove;
a movement portion that is connected to the lens holding frame, rotatably holds the rotation member, and moves in an axial direction of the lead screw as the lead screw rotates; and
a biasing portion that biases the rotation member toward the lead screw in a direction orthogonal to the axial direction of the lead screw.

14. An imaging device comprising the lens barrel according to claim 1.

15. A driving device comprising:
a drive source;
a lead screw that has a thread groove formed thereon and is rotationally driven by the drive source;
a ring-shaped member that has a groove on an inner periphery thereof, the groove being in contact with the thread groove;
a holding member that rotatably holds the ring-shaped member;
a biasing portion that biases the ring-shaped member toward the lead screw in a direction orthogonal to an axis of the lead screw,
wherein the ring-shaped member moves in an axial direction of the lead screw together with the holding member while rotating in accordance with rotation of the lead screw.
